(19) United States
(12) Patent Application Publication
(10) Pub. No.: US 2003/0126413 A1
(43) Pub. Date: Jul. 3, 2003

(54) PROCESSOR SYSTEM INCLUDING INTERNAL ADDRESS GENERATOR FOR IMPLEMENTING SINGLE AND BURST DATA TRANSFERS

(76) Inventors: TONY S. EL-KIK, ALLENTOWN, PA (US); LAURENCE EDWARD BAYS, ALLENTOWN, PA (US); ERIC WILCOX, ALLENTOWN, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/478,714

(22) Filed: Jan. 6, 2000

(51) Int. Cl. G06F 9/00

(52) U.S. Cl. 712/225; 712/34

(57) ABSTRACT

A dual processor system comprises a first processor coupled to a second processor by a system address bus and a data bus. The second processor has a control register having a control register system address, an internal memory, a data register having a data register system address and coupled to the internal memory, and an internal address generator coupled to the control register and to the internal memory. The control word is written into the control register when the first processor places a control word having a burst mode bit and a starting internal address on the data bus and asserts the control register system address on the system address bus. The second processor enters a burst mode in which the internal address generator selects consecutive memory locations of the internal memory, starting at the starting internal address specified in the control word stored in the control register, during subsequent data transfer cycles, when the control word has a burst mode bit indicating burst mode. This enables both single and burst data transfers between the first processor and the memory of the second processor.

### BACKGROUND OF THE INVENTION

1. Field of the Invention

The present invention relates to burst and single data transfers between processors.

2. Description of the Related Art

Computer processors often utilize a second processor, or co-processor, to perform processing such as mathematical computation, on data, to reduce the processing load on the first processor or to take advantage of a specialized co-processor such as a math co-processor. The data bytes or words to be processed by the co-processor are transferred via a data bus from the first processor into certain memory locations of a memory bank or block of the co-processor. The co-processor then processes the data, and returns the result or processed data back to the first processor, again via the data bus.

To transfer a word or other unit of data from the processor to a specified memory location of the co-processor, the processor must provide the co-processor with both the destination address plus the data word itself. A bus cycle may be employed for this purpose, where the destination address is placed on the bus, followed by the data to be written. The data to be written is typically a byte (8 bits), a word (16 bits), or a double word (32 bits) limited by the width of the bus and the amount of data to be written.

If a large block of data needs to be transferred from the processor to the co-processor, the need to provide to the co-processor the destination address for each subsequent word can either slow down the data transfer and/or require a large number of address and data lines so that the entire co-processor memory can be addressed by the processor in parallel with data words placed on the data bus.

There is a need, therefore, for improved data transfers from the processor to the co-processor memory.

### SUMMARY

In the present invention, a dual processor system comprises a first processor coupled to a second processor by a system address bus and a data bus. The second processor has a control register having a control register system address, an internal memory, a data register having a data register system address and coupled to the internal memory, and an internal address generator coupled to the control register and to the internal memory. The control word is written into the control register when the first processor places a control word having a burst mode bit and a starting internal address on the data bus and asserts the control register system address on the system address bus. The second processor enters a burst mode in which the internal address generator selects consecutive memory locations of the internal memory, starting at the starting internal address specified in the control word stored in the control register, during subsequent data transfer cycles, when the control word has a burst mode bit indicating burst mode. This enables both single and burst data transfers between the first processor and the memory of the second processor.

### BRIEF DESCRIPTION OF THE DRAWINGS

FIG. 1 is a block diagram of a dual processor system, in accordance with an embodiment of the present invention;

FIG. 2 is a timing diagram illustrating a multiple writes operation in the dual processor system of FIG. 1; and

FIG. 3 is a timing diagram illustrating a multiple reads operation in the dual processor system of FIG. 1.

### DESCRIPTION OF THE PREFERRED EMBODIMENT

In the present invention, a bus interface architecture and method are provided to permit the transfer of both single and burst data streams between processor and co-processor while employing a minimum number of external address lines. By minimizing the number of external address lines required, the associated number of pins and other costs and drawbacks are also reduced.

A single data transfer or single write operation is an operation in which a single word of data is transferred from the first processor to a specified location in the co-processor memory. In burst data transfers, an entire block of contiguous data is transferred, to a contiguous section of co-processor memory beginning at a specified memory location.

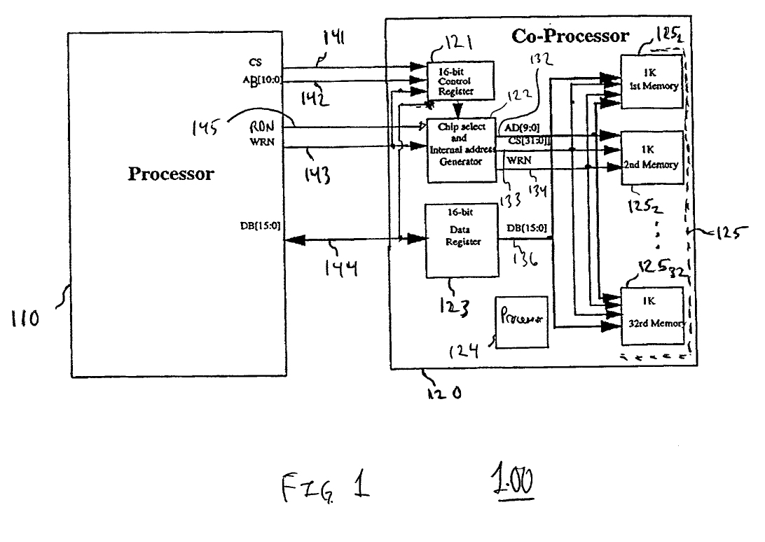

Referring now to FIG. 1, there is shown a block diagram of a dual processor system 100, in accordance with an embodiment of the present invention. System 100 comprises first or main processor 110 and second processor or co-processor 120, which are intercoupled in accordance with the bus interface architecture of the present invention. In particular, processors 110, 120 are interconnected by CS (chip select) line 141, 11-bit system address bus (AB) 142, WRN (write-not) line 143, RDN (read-not) line 145, and 16-bit data bus (DB) 144. System address bus 142 is used to select a particular device in the computer system 100, e.g. to select co-processor 120 in a system having many selectable devices such as other co-processors (not shown), or to select control register 121 of co-processor 120, where control register 121 is one of several other addressable units (not shown) of co-processor 120.

Co-processor 120 comprises 16-bit control register 121, chip select and internal address generator block 122, 16-bit data register, memory block(s) 125, and processor 124. Processor 124 performs dedicated processing on specified data stored in specified locations or addresses of memory 125, and provides processed data or other type of result which is to be transferred to processor 110. In an embodiment, memory 125 is divided into 32 banks or blocks 125₁, 125₂, . . . 125₃₂, each of which stores 1K words, for a total word storage of 32K. In one embodiment, the control register 121 has a specified system address (e.g., 370), and the data associated with control register 121 has a specified system address (e.g., 400). That is, when the address bus 142 has the system address of the control register 121, a word of data on the data bus 144 can be written into the control register. Similarly, when the address bus has the system address of the data 125, a word of data on data bus 144 will be received by data register 123 and written into the internal memory location of memory 125 as specified by signals generated by chip select and internal address generator unit 122.

In order to provide the ability for processor 110 to fully address every memory location of memory 125, a separate address bus could be provided. This would permit a single word to be written to a specified location in memory 125, by placing the word on data bus 144, and the (internal) address on the special address bus, in a given bus cycle (the address on system address bus 142 would be the data address, e.g. the address sufficient to enable memory 125 to be written to). This configuration would also permit a block of words to be written in succession, by placing each subsequent word on data bus 144 at the same time as its internal address is placed on the special address bus. Thus, during such data write operations, the address bus 142 would also need to have the data address for the device to be written to (e.g., address 400 for memory 125). However, for a 32k word internal memory such as memory 125, for example, the separate address bus would have 15 lines and would require an associated number of extra pins on both processors 110, 120, and is thus an undesirable feature.

In the present invention, both single data and burst data transfers of data from processor to co-processor, and vice-versa, are provided, without requiring the extra address lines, pins, and associated complexity of a special address bus. To write either a single word of data or a block of data words in burst mode, processor 144 first strobes the CS line 141, and selects the control register 121 by placing its 11-bit system address on system address line 142 (e.g., address 370). The WRN line 143 is also strobed with a logic low signal. Thus, in a first bus cycle, a 16-bit control word is transferred via data bus 144 to 16-bit control register 121.

This control word specifies a unique (internal) address of memory 125 (15 bits total) as well as whether or not control register 121 should implement auto-increment (burst) mode. In an embodiment, the address field of the control word comprises two fields: a 5-bit field which selects one of the 32 memory banks of memory 125; and a 10-bit field which specifies a unique memory address location within a given selected memory bank 125₁. The format of the control word is illustrated in Table 1 below:

TABLE 1
Control Word

| BIT 15 | BITS[14:10] | BITS[9:0] |
|---|---|---|
| Auto-increment mode | Memory bank selected | Starting address within |
| | | selected bank |

The address specified is referred to as a “starting address,” because it is the first or starting address of a contiguous section of memory into/from which a block of words is written/read during a burst data transfer. In the case of a single data transfer, the starting address is the sole address, and specifies which memory location of a selected memory bank the single word will be written to or read from. After the data bus 144 is used to transfer the control word to control register 121, it is used to transfer one data word in the next bus cycle (for a single data transfer) or a succession of data words during subsequent bus cycles (for a burst data transfer). During this data transfer mode, instead of the system address of control register 121 (e.g., address 370), the system address of data register 123 is placed on address bus 142 (e.g., address 400). This causes co-processor to route the subsequently received succession of data words as data into data register 123 instead of as a control word written into control register 121. Thus, so long as address bus 142 asserts the data address for the data register 123, co-processor continues to write subsequently received words from data bus 144 into consecutive locations of memory 125. When processor 110 wishes to end the burst data transfer, it may, for example, assert the system address of some other control register, or of control register 121 and write all 0s into the control register.

After the initial control word is written into control register 121, chip select/internal address generator 122 decodes the starting address and memory bank select bits in control register 121, to select the proper memory location of memory 125 for a current read or write operation. Local address bus 132 contains the same starting address as specified in the control word starting address field. CS bus 133 selects the memory bank 125₁ that is specified in the memory bank selected field of the control word. For a write operation, for example, the WRN signal 134 permits a write to the selected memory bank, of the word appearing on local or internal data bus 136, which receives the data word provided on external data bus 144 during the bus cycle following the control word. For a read operation, a RDN signal (not shown) is provided by chip select/internal address generator to the memory 125.

When the processor 110 wishes to write or read a single data word or burst of data words to or from memory 125, it asserts the appropriate CS, RDN, and WRN signals on the respective lines, asserts the proper address for control register 121 on the address line 142, and transfer the control word via data bus 144 to control register 121. For a single data transfer, the next bus cycle uses the data bus 144 to transfer a word from or to a specified memory location of memory 125, while asserting the data register 123 address on address bus 142. For a burst data transfer, the next N bus cycles transfer subsequent data words to or from successively incremented memory locations from memory 125, starting at the starting memory location or address. In this burst data transfer mode, the internal address generator of chip select/internal address generator 122 knows to increment the internal address after each bus cycle, until address bus 142 no longer asserts the data address, because bit 15 of the control register indicates auto-increment (burst) mode.

Thus, for a write or read operation, processor 110 programs control register 121 with a 16 bit control word, which is then applied to chip select/internal address generator block 122. If bit 15 (auto-increment) is zero, then bits [9:0] of the control register are used as the internal address of the (sole) memory location that is to be read or written. If, on the other hand, bit 15 (auto-increment) is one, then bits [9:0] of the control register indicate only the starting internal address of the memory location that is to be read or written. Bits [14:10] of the control word in the control register 121 are decoded by chip select/internal address generator block 122, which selects the appropriate 32k memory bank 125ᵢ. Once the internal CS and internal starting address have been determined, processor 110 can then write to or read from memory 125 of co-processor 120 using only a single 16-bit data register 123 and data bus 144.

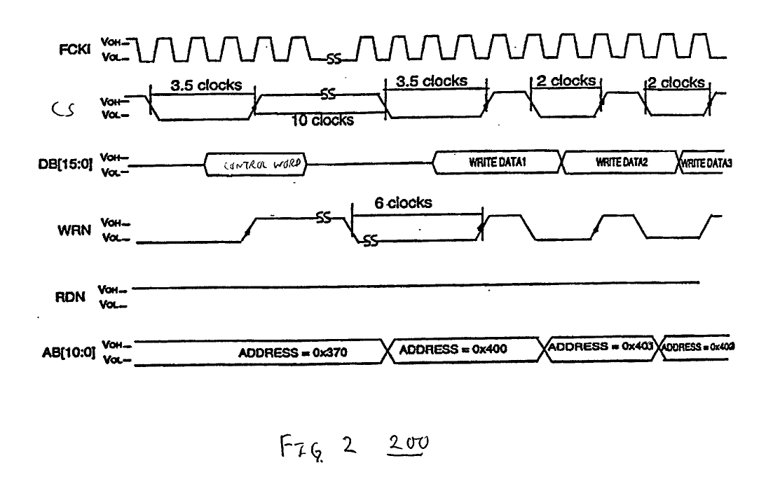

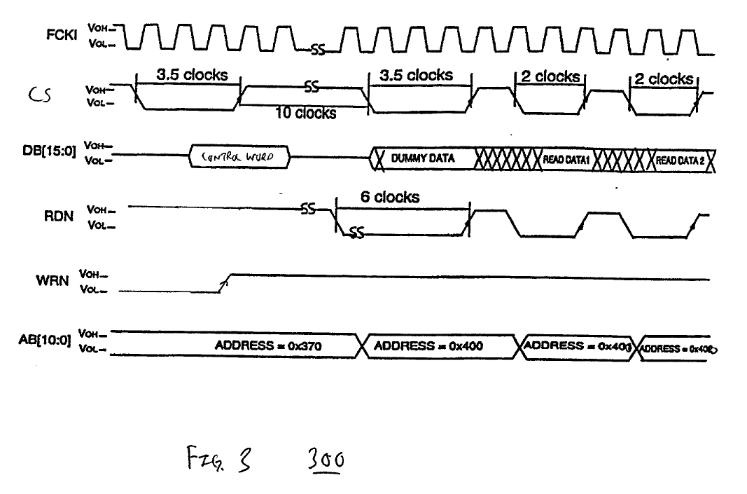

Referring now to FIGS. 2 and 3, there is shown, in FIG. 2, a timing diagram 200 illustrating a multiple (burst) writes operation in the dual processor system 100 of FIG. 1, in further detail. FIG. 3 shows a timing diagram 300 illustrating a multiple (burst) reads operation in the dual processor system 100 of FIG. 1. Each timing diagram 200, 300 shows the states of the signals between main processor 110 and co-processor 120, in particular, the CS signal, the address bus signal AB[10:0], the read and write data (not) signals RDN, WRN, and the data bus signal DB[15:0]. These signals are shown with respect to a system clock signal FCKI.

In timing diagram 200, the control word is placed on data bus 144, and is written into control register 121 by the control register system address (e.g., 370) being asserted on system address bus 142 while the write signal is asserted (active low) and raised to high. The initial control word is written into control register 121 in similar fashion at the beginning of a burst read operation as shown in FIG. 3. Thus, at this point, control register 121 and chip select/internal address generator knows that auto-increment mode is to be entered and the starting internal address to be written to (or read from in the case of burst read mode).

Thus, after the initial control word writing phase, the data address (e.g., 400) is asserted by address bus 142. In burst write mode, subsequent data words are asserted on data bus 144, and the write signal WRN is pulsed to cause these to be written to data register 123. Data register then writes these words into memory 125, at appropriate locations as selected by the signals from chip select/internal address generator block 122. In burst write mode, the read signal causes data retrieved from memory 125 to be placed on data bus 144, where it can be read by processor 110. So long as the data address (e.g. 400) of data register 123 is asserted by address bus 142, co-processor 120 continues to write data to (in the burst write mode) or read data from (in burst read mode) memory 125.

In an embodiment, processor 110 can only access one of the memory banks of memory 125 at a time. In this case, to access another 1k memory bank of memory 125, processor 110 must re-write control register 121 with a new control word having new starting address and memory block selected fields. In an alternative embodiment, system 100 is configured so that, if necessary, during the auto-increment mode, when the last memory location of a memory bank 125ᵢ is reached but more data words remain to be transferred, chip select/internal address generator 122 automatically increments the chip select bits to select the next memory bank 125ᵢ₊₁ and resets the internal address for that selected memory bank starting at address 0.

Some or all of the components of the transceivers of system 100 of the present invention may be fabricated as an integrated circuit (IC), within a semiconductor chip. Chips are formed in the substrate of a physical wafer, e.g. a silicon wafer. Typically, several chips are formed in each wafer. A wafer is a very thin, flat disc of a given diameter. The manufacturing process consists of operations on the surface and substrate of the wafer to create a number of chips. Once the wafer is completely processed, it is cut up into the individual chips, the size of which depends on the number of components and complexity of each chip.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A dual processor system, comprising:
(a) a first processor coupled to a system address bus and a data bus; and
(b) a second processor coupled to the system address bus and to the data bus, the second processor comprising a control register having a control register system address, an internal memory, a data register having a data register system address and coupled to the internal memory, and an internal address generator coupled to the control register and to the internal memory, wherein:
the control word is written into the control register when the first processor places a control word having a burst mode bit and a starting internal address on the data bus and asserts the control register system address on the system address bus; and
the second processor enters a burst mode in which the internal address generator selects consecutive memory locations of the internal memory, starting at the starting internal address specified in the control word stored in the control register, during subsequent data transfer cycles, when the control word has a burst mode bit indicating burst mode.

2. The dual processor system of claim 1, wherein the system is implemented as an integrated circuit.

3. The dual processor system of claim 1 wherein the second processor remains in the burst mode only so long as the first processor asserts the data register system address on the system address bus.

4. The dual processor system of claim 1, wherein, in a write burst mode, the first processor asserts the data register system address on the system address bus and writes subsequent data words on the data bus, and the internal address generator selects consecutive memory locations of the internal memory, starting at the starting internal address, whereby the subsequent data words are written into the consecutive memory locations.

5. The dual processor system of claim 1, wherein, in a read burst mode, the first processor asserts the data register system address on the system address bus and reads subsequent data words on the data bus, the internal address generator selects consecutive memory locations of the internal memory, starting at the starting internal address, and the data register reads data words at the consecutive memory locations and places said data words on the data bus, whereby the subsequent data words are read from the consecutive memory locations by the first processor.

6. The dual processor system of claim 1, wherein the second processor is a co-processor.

7. The dual processor system of claim 1, wherein:
the control word is written into the control register when the first processor places a control word having a burst mode bit and a starting internal address on the data bus and asserts the control register system address on the system address bus; and
the second processor enters a single data transfer mode in which the internal address generator selects the starting internal address specified in the control word stored in the control register, during a next data transfer cycles when the control word has a burst mode bit that does not indicate burst mode.

8. The dual processor system of claim 1, wherein the first processor and second processor are intercoupled by the system address bus, the data bus, a chip select line, a read signal line, and a write signal line.

9. The dual processor system of claim 1, wherein:
the internal memory comprises a plurality of memory blocks;
the control word comprises the burst mode bit field, a memory bank field which specifies a selected memory bank of the plurality of memory banks, and an internal bank address field which specifies the starting internal bank address within the selected memory bank; and
the internal address generator determines the starting internal address from the selected memory bank and the internal bank address of the control word.

10. An integrated circuit having a second processor for transferring data with a first processor coupleable to the second processor via a system address bus and a data bus, the second processor comprising a control register having a control register system address, an internal memory, a data register having a data register system address and coupled to the internal memory, and an internal address generator coupled to the control register and to the internal memory, wherein:
the control word is written into the control register when the first processor places a control word having a burst mode bit and a starting internal address on the data bus and asserts the control register system address on the system address bus; and
the second processor enters a burst mode in which the internal address generator selects consecutive memory locations of the internal memory, starting at the starting internal address specified in the control word stored in the control register, during subsequent data transfer cycles, when the control word has a burst mode bit indicating burst mode.

11. The integrated circuit of claim 10, wherein the second processor remains in the burst mode only so long as the first processor asserts the data register system address on the system address bus.

12. The integrated circuit of claim 10, wherein, in a write burst mode, the first processor asserts the data register system address on the system address bus and writes subsequent data words on the data bus, and the internal address generator selects consecutive memory locations of the internal memory, starting at the starting internal address, whereby the subsequent data words are written into the consecutive memory locations.

13. The integrated circuit of claim 10, wherein, in a read burst mode, the first processor asserts the data register system address on the system address bus and reads subsequent data words on the data bus, the internal address generator selects consecutive memory locations of the internal memory, starting at the starting internal address, and the data register reads data words at the consecutive memory locations and places said data words on the data bus, whereby the subsequent data words are read from the consecutive memory locations by the first processor.

14. The integrated circuit of claim 10, wherein the second processor is a co-processor.

15. The integrated circuit of claim 10, wherein the first processor and second processor are intercoupled by the system address bus, the data bus, a chip select line, a read signal line, and a write signal line.

16. The integrated circuit of claim 10, wherein:
the internal memory comprises a plurality of memory blocks;
the control word comprises the burst mode bit field, a memory bank field which specifies a selected memory bank of the plurality of memory banks, and an internal bank address field which specifies the starting internal bank address within the selected memory bank; and
the internal address generator determines the starting internal address from the selected memory bank and the internal bank address of the control word.
